(19) United States
(12) Patent Application Publication
(10) Pub. No.: US 2009/0124967 A1
(43) Pub. Date: May 14, 2009

(54) DEVICES AND METHODS FOR REMOVAL OF LEUKOCYTES FROM BREAST MILK

(75) Inventor: Dorothea ZUCKER-FRANKLIN, New York, NY (US)

Correspondence Address: NIXON PEABODY LLP - PATENT GROUP, 1100 CLINTON SQUARE, ROCHESTER, NY, 14604, US

(73) Assignee: NEW YORK UNIVERSITY, New York, NY (US)

(21) Appl. No.: 12/352,243

(22) Filed: Jan. 12, 2009

Related U.S. Application Data
(63) Continuation of application No. 10/796,747, filed on Mar. 9, 2004, now abandoned.
(60) Provisional application No. 60/455,262, filed on Mar. 14, 2003.

(51) Int. Cl. A61J 13/00; B01D 37/00; A61J 11/04; A61J 9/00

(52) U.S. Cl. 604/76; 210/767; 215/11.1

(57) ABSTRACT

The present invention relates to a nipple shield device or baby bottle nipple for removing leukocytes from breast milk with a filter attached to the nipple shield or baby bottle nipple at a location permitting removal of leukocytes from breast milk. A method of removing leukocytes from breast milk involving filtering breast milk with a filter that removes leukocytes is also disclosed.

This application is a continuation of U.S. patent application Ser. No. 10/796,747, filed Mar. 9, 2004, which claims the benefit of U.S. Provisional Patent Application Ser. No. 60/455,262, filed Mar. 14, 2003, which are hereby incorporated by reference in their entirety.

### FIELD OF THE INVENTION

The present invention relates to methods and devices for removing leukocytes from breast milk.

### BACKGROUND OF THE INVENTION

The benefits of breast feeding are well recognized and require no elaboration. Volumes have been written on this subject (e.g., Lawrence et al., Breast Feeding, 5^{th} edition, Mosby Inc., St. Louis, Mo. (1999)). Apart from the nutritional, physiologic, and psycho-social values pointed out in numerous publications, breast feeding incurs no financial burden. However, as is true in other areas of medicine, what seems physiologic or “natural” is not always flawless. Breast milk is a case in point. In general, the immunoglobulins contained in breast milk (Stoliar et al., “Secretory IgA Against Enterotoxin in Breast Milk,” Lancet, 1:1258 (1976); Pickering et al., “Human Milk Humoral Immunity and Infant Defense Mechanisms,” In: Howell, eds. Human Milk in Infant Nutrition and Health, Thomas, Springfield, Ill. (1986); Ogra et al., “Immunologic Aspects of Human Colostrum and Milk. I. Distribution Characteristics and Concentrations of Immunoglobulins at Different Times after the Onset of Lactation,” J Pediatr., 92:546 (1978)) are likely to be protective to the infant, who has not yet been exposed to environmental microorganisms or other pathogens (Ogra et al., Components of Immunology Reactivity in Human Colostrum and Milk in Immunology of Breast Milk, Raven Press, New York (1979); Ogra et al., “Immunologic Aspects of Human Colostrum and Milk. II. Characteristics of Lymphocyte Reactivity and Distribution of E-rosette Forming Cells at Different Times After the Onset of Lactation,” J. Pediatr., 92:550 (1978)). However, immunoglobulins in breast milk may include antibodies directed against the infant's red blood cells in cases where mother and infant are not Rh or ABO compatible (Wiener, “Diagnosis and Treatment of Anemia in the Newborn Caused by Occult Placental Hemorrhage,” Am. J. Obstetrics and Gynecol., 56:717-722 (1948); Bowman, “Fetomaternal ABO Incompatibility and Erythroblastosis Fetalis,” Vox Sang., 50:104-106 (1986); Beer et al., “Immunologic Benefits and Hazards of Milk in Maternal-Perinatal Relationships,” Ann. Int. Med., 83:865 (1975)). Breastfeeding of neonates with alloimmune hemolytic disease, be it attributable to Rh or ABO incompatibility, would add insult to injury and, therefore, it is usually interdicted.

It is not as commonly recognized that breast milk also contains a large variety of cells. While some of these cells represent ductal epithelial cells and their fragments, the presence of leukocytes is by no means insignificant (Bhaskaran et al., “Bactericidal Activity of Human Milk Leukocytes,” Acta Paediatr. Scand., 70:87 (1981); Zhang et al., “Influence of Breast Feeding on the Cytotoxic T Cell Repertoire in Man,” Transplantation, 52:914-916 (1991)). Colostrum contains about 10,000 lymphocytes per cu mm. T-lymphocytes make up about 2000 cells per cu mm (Ogra et al., Components of Immunology Reactivity in Human Colostrum and Milk in Immunology of Breast Milk, Raven Press, New York (1979); Ogra et al., “Immunologic Aspects of Human Colostrum and Milk. II. Characteristics of Lymphocyte Reactivity and Distribution of E-rosette Forming Cells at Different Times After the Onset of Lactation,” J. Pediatr., 92:550 (1978)). Similar values have been reported by others. Because peptic enzyme activity and acid secretion are very low in newborn infants, lymphoid cells survive in their stomach and intestine. In addition, lymphocytes are known to traverse the mucosal wall. Therefore, breastfed infants may be tolerant to maternal antigens (Beer et al., “Immunologic Benefits and Hazards of Milk in Maternal-Perinatal Relationships,” Ann. Int. Med., 83:865 (1975)). It has even been claimed that maternal renal allografts have a better survival rate in individuals who were breastfed than in individuals who were not (Zhang et al., “Influence of Breast Feeding on the Cytotoxic T Cell Repertoire in Man,” Transplantation, 52:914-916 (1991)).

More importantly, lymphocytes may carry microorganisms, such as retroviruses. This pertains particularly to the Human Lymphotropic Virus Type I (HTLV-I). Soon after the discovery of this virus (Poiesz et al., “Detection and Isolation of Type C Retrovirus Particles From Fresh and Cultured Lymphocytes of a Patient With Cutaneous T Cell Lymphoma,” Proc. Nat. Acad. Sci., 77:7415 (1980); Yoshida et al., “Isolation and Characterization of Retrovirus From Cell Lines of Human Adult T Cell Leukemia and Its Implication in the Disease,” Proc. Nat. Acad. Sci., 79:2031 (1982)), which causes leukemias, lymphomas, and a variety of inflammatory diseases, it was realized that this virus is transmitted sexually from male to female, by blood transfusion, and from mother to infant by breast feeding (Sugiyama et al., “Significance of Post-Natal Mother-to-Child Transmission of HTLV-I on the Development of Adult T Cell Leukemia/Lymphoma,” J. Med. Virol., 20:253 (1986); Hino et al., “Intervention of Maternal Transmission of HTLV-I in Nagasaki, Japan,” Leukemia, 94:S68 (1993); Hirose et al., “Milkborne Transmission of Human T Cell Leukemia Virus Type I in Rabbits,” Virology, 162:487 (1988)). Transmission of HTLV-I to animals via breast milk obtained from sero-positive persons had also been shown (Yamamouchi et al., “Oral Transmission of Human Leukemia Virus Type I into a Common Marmoset as an Experimental Model for Milk-Borne Transmission,” Jpn. J. Cancer Res., 76:481 (1985)). Therefore, breast feeding by mothers, who were shown to have antibodies to HTLV-I, was prohibited in Japan (Hino et al., “Breaking the Cycle of HTLV-I Transmission Via Carrier Mothers' Milk,” Lancet, II:158 (1987)). In the United States, HTLV-I antibody positive blood has not been used for transfusion since 1988 (Centers for Disease Control and Prevention, Licensure and Screening Tests for Antibody to Human T Lymphotropic Virus I (1988)).

Perhaps of even greater significance is, that in areas of the world where the virus is not endemic, e.g., in the United States, the prevalence of individuals who do not carry intact viruses but who, nevertheless, have the Tax sequence of HTLV-I in their lymphocytes usually goes unrecognized. Such individuals test serologically negative for antibodies to the structural proteins of the virus. However, it should be appreciated that Tax DNA and its gene product p40Tax are responsible for the pathogenicity of this virus (for review, see Rosenblatt et al., “Transactivation of Cellular Genes by Human Retroviruses,” Current Topics in Microbiol. & Immunol., 193:25-49 (1995)). This was first realized with the observation that patients with the cutaneous T cell lymphoma, Mycosis Fungoides, harbor the Tax sequence of HTLV-I in their peripheral blood and skin-infiltrating lymphocytes without having antibodies to the structural proteins of the virus (Zucker-Franklin et al., “The Role of Human Lymphotropic Viruses (HTLV-I and II) in Cutaneous T Cell Lymphomas,” Seminars in Dermatol., 13:160-165 (1994); Zucker-Franklin et al., “Human T Cell Lymphotropic Virus Type I (HTLV-1) Tax Among American Blood Donors,” Clin. Diagnostic Laboratory Immunology, 5:831-835 (1998)). In fact, some of the healthy relatives of these patients had served as blood donors, since they were found to be serologically negative for antibodies to the structural proteins of the virus by Western blot, a test still being used in US blood banks to rule out infection with HTLV-I. It has been shown that about 8% of blood donors in New York City carry HTLV-I Tax in their lymphocytes (Zucker-Franklin et al., “Human T Cell Lymphotropic Virus Type I (HTLV-1) Tax Among American Blood Donors,” Clin. Diagnostic Laboratory Immunology, 5:831-835 (1998)). In some inflammatory diseases, e.g., rheumatoid arthritis, the prevalence of HTLV-I Tax positivity is at least 3 times higher than in healthy individuals (Zucker-Franklin et al., “Prevalence of HTLV-I Tax in a Subset of Patients With Rheumatoid Arthritis,” Clin. Exp. Rheumatol. 20:161-169 (2002)). This would, of course, also pertain to breastfeeding women. Moreover, it has been demonstrated that transfusion of Tax-positive human lymphocytes into rabbits renders these animals HTLV-I positive (Zucker-Franklin et al., “Transmission of Human T Cell Lymphotropic Virus Type I Tax into Rabbits by Transfusion of “Tax Only”—Positive Human Cells,” Clin. Diagnost. Lab. Immunol., 5:831-835 (1998)).

For all the reasons cited in the foregoing (allo-immunization, infections, etc.), it would be beneficial to eliminate leukocytes from breast milk.

The present invention is directed to achieving these objectives.

### SUMMARY OF THE INVENTION

The present invention relates to a nipple shield device for removing leukocytes from breast milk. The device includes a nipple shield having a base and a protrusion that is shaped to conform to a mammalian female areola and nipple, where the protrusion has one or more holes permitting intake of breast milk by an infant, and a filter attached to the nipple shield at a location permitting removal of leukocytes from breast milk.

The present invention also relates to a nipple device for removing leukocytes from breast milk. The device includes a nipple having a base and a protrusion, where the protrusion has one or more holes permitting intake of breast milk by an infant, and a filter attached to the nipple at a location permitting removal of leukocytes from breast milk.

Another aspect of the present invention relates to a method of removing leukocytes from breast milk. The method involves filtering breast milk with a filter that removes leukocytes.

The present invention provides a convenient and effective way to remove leukocytes from breast milk by incorporating a filter that is capable of removing leukocytes into a nipple shield device, which has been primarily used to protect cracked or otherwise sore nipples. Alternatively, the same type of filter can be incorporated into nipples of bottles used for feeding breast milk. The present invention, therefore, permits feeding breast milk to infants without the hazards attributed to the cells contained in breast milk.

### BRIEF DESCRIPTION OF THE DRAWINGS

FIG. 1 is a perspective view of the nipple shield device of the present invention.

FIG. 2 is a cross-sectional side view of FIG. 1 taken along line 2-2.

FIG. 3 is a cross-sectional side view of an alternative embodiment of the nipple shield device of the present invention.

FIG. 4 is a perspective view of the nipple device of the present invention.

FIG. 5 is a cross-sectional side view of FIG. 4 taken along line 5-5.

FIG. 6 is a perspective view of the nipple device of the present invention shown in FIG. 4 and a nursing bottle and a securing ring.

### DETAILED DESCRIPTION OF THE INVENTION

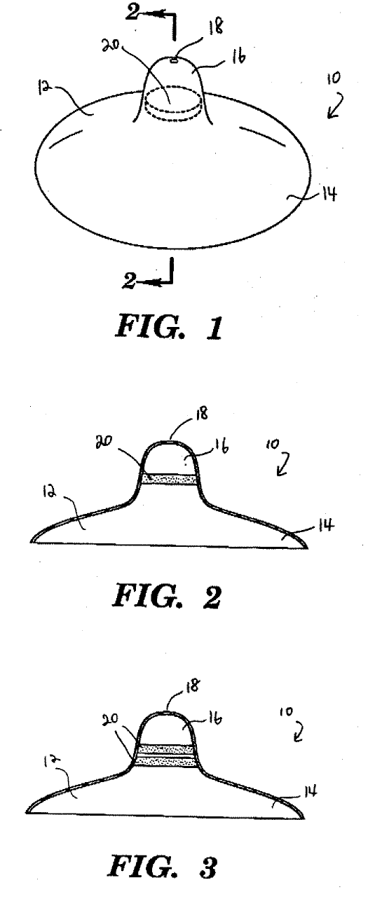

FIG. 1 is a perspective view of the nipple shield device of the present invention. Nipple shield device 10 includes nipple shield 12 having base 14 and protrusion 16. Protrusion 16 has one or more holes 18 permitting intake of breast milk by an infant. Nipple shield device 10 also includes filter 20 attached to nipple shield 12 at a location permitting removal of leukocytes from breast milk.

Nipple shield 12 having base 14 and protrusion 16 is shaped to conform to a mammalian female areola and nipple. Nipple shield 12 can take a variety of forms, substantially conforming to larger or smaller nipple and areolar regions. Such nipple shields are known in the art and are commercially available from companies such as Medela, Inc. (McHenry, Ill.). Specifically, nipple shield 12 is shaped such that suction is created between nipple shield device 10 and the nipple and areolar region when nipple shield device 10 is placed over the nipple and areolar region and sucked on by an infant for intake of breast milk.

Nipple shield 12 can be made of a variety of flexible materials to allow maximum comfort for both the nursing mother and the infant and for ease of use. Specifically, nipple shield 12 can be made of a soft, flexible, and transparent material such as silicone or rubber.

Filter 20 can be attached inside of protrusion 16, as shown by FIGS. 1 and 2. FIG. 2 is a cross-sectional side view of FIG. 1 taken along line 2-2. Alternatively, multiple filters 20 can be attached at a plurality of different locations along protrusion 16 to permit serial filtering of breast milk, as shown by FIG. 3.

Filter 20 can be any filter that is capable of removing leukocytes from a liquid, such as the leukocyte depleting filters commercially available from Pall Corporation (Glen Cove, N.Y.) or disclosed by U.S. Pat. Nos. 5,258,127 and 5,744,047 to Gsell et al., which are hereby incorporated by reference in their entirety. Other suitable filters include, but are not limited to, the leukocyte reduction filters disclosed by U.S. Pat. No. 6,048,464 to Tanaka et al., U.S. Pat. No. 6,267,898 to Fukuda et al., and U.S. Pat. No. 6,337,026 to Lee et al., which are hereby incorporated by reference in their entirety.

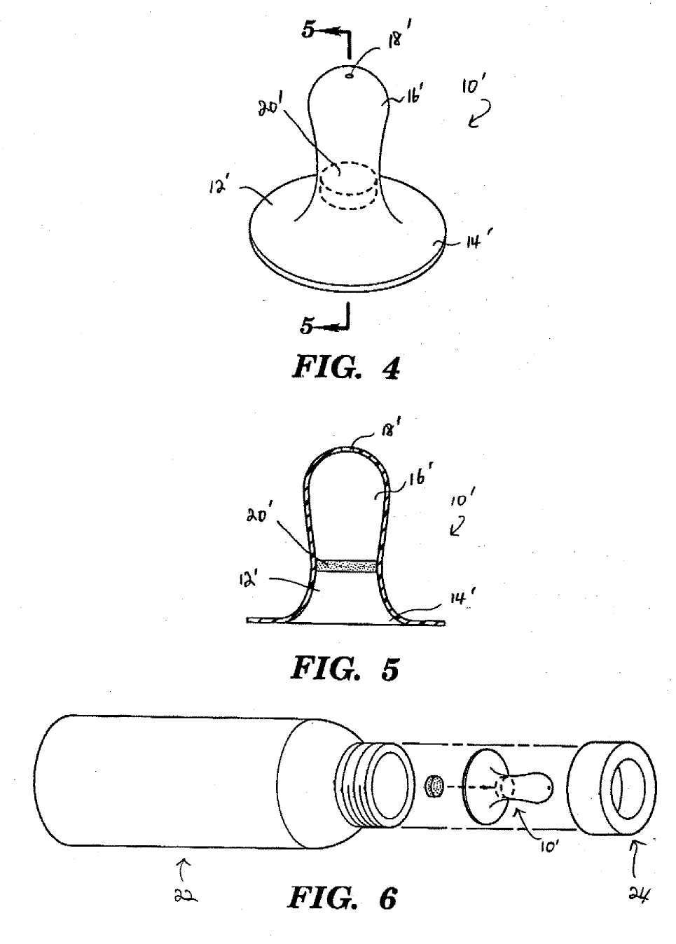

FIG. 4 is a perspective view of the nipple device of the present invention. Nipple device 10′ includes nipple 12′ having base 14′ and protrusion 16′. Protrusion 16′ has one or more holes 18′ permitting intake of breast milk by an infant. Device 10′ also includes filter 20′ attached to nipple 12′ at a location permitting removal of leukocytes from breast milk.

Nipple 12′ can take a variety of forms and sizes, as known in the art, as long as it can be used by an infant for intake of breast milk from a nursing bottle. Nipple 12′ can be made of a variety of flexible materials to allow maximum comfort for the infant and ease of manufacture. Specifically, nipple 12′ can be made of a soft, flexible material such as silicone or rubber.

Filter 20′ can be attached inside of protrusion 16′, as shown by FIG. 4. FIG. 5 is a cross-sectional side view of FIG. 4 taken along line 5-5. Alternatively, multiple filters can be attached at a plurality of different locations along protrusion 16′ to permit serial filtering of breast milk, like the embodiment shown in FIG. 3.

As shown by FIG. 6, the above-described nipple device 10′ can be part of a nursing bottle, where nipple device 10′ is fitted onto nursing bottle 22 and secured with securing ring 24 for feeding breast milk from a nursing bottle to an infant.

The present invention also relates to a method of removing leukocytes from breast milk. The method involves filtering breast milk with a filter that removes leukocytes, like the filter described above.

In accordance with the present invention, nipple shield device 10 can be used in a method of removing leukocytes from breast milk. In particular, nipple shield device 10 would be placed over a nipple and areolar region of a mammalian female and an infant would be allowed to suck on the protrusion part of the device to take in breast milk from a nursing mother.

Alternatively, in accordance with the present invention, nipple device 10′ can be used in a method of removing leukocytes from breast milk. In particular, nipple device 10′ can be placed over a nursing bottle and secured with a securing ring, as shown by FIG. 6. An infant would be allowed to suck on the protrusion part of the device to take in breast milk collected in a nursing bottle.

Although the invention has been described in detail, for the purpose of illustration, it is understood that such detail is for that purpose and variations can be made therein by those skilled in the art without departing from the spirit and scope of the invention which is defined by the following claims.

What is claimed is:

1. A nipple shield device for removing leukocytes from breast milk comprising:
a nipple shield having a base and a protrusion that is shaped to conform to a mammalian female areola and nipple, wherein said protrusion has one or more holes permitting intake of breast milk by an infant; and
a filter attached to the nipple shield at a location permitting removal of leukocytes from breast milk.

2. The nipple shield device according to claim 1, wherein said filter is attached inside of said protrusion.

3. The nipple shield device according to claim 1, wherein said filter is a leukocyte reduction filter.

4. The nipple shield device according to claim 1, wherein said filter is attached at a plurality of different locations along the protrusion to permit serial filtering of breast milk.

5. The nipple shield device according to claim 1, wherein said nipple shield is made of a flexible material.

6. The nipple shield device according to claim 5, wherein the flexible material is silicone or rubber.

7. A nipple device for removing leukocytes from breast milk comprising:
a nipple having a base and a protrusion, wherein said protrusion has one or more holes permitting intake of breast milk by an infant; and
a filter attached to the nipple at a location permitting removal of leukocytes from breast milk.

8. The nipple device according to claim 7, wherein said filter is attached inside of said protrusion.

9. The nipple device according to claim 7, wherein said filter is a leukocyte reduction filter.

10. The nipple device according to claim 7, wherein said filter is attached at a plurality of different locations along the protrusion to permit serial filtering of breast milk.

11. The nipple device according to claim 7, wherein said nipple is made of a flexible material.

12. The nipple device according to claim 11, wherein the flexible material is silicone or rubber.

13. A nursing bottle on to which the nipple device according to claim 7 is fitted.

14. A method of removing leukocytes from breast milk comprising:
filtering breast milk with a filter that removes leukocytes.

15. The method according to claim 14, wherein said filter is part of a nipple shield device for breastfeeding an infant, said nipple shield device comprising:
a nipple shield having a base and a protrusion that is shaped to conform to a mammalian female areola and nipple, wherein said protrusion has one or more holes permitting intake of breast milk by an infant, and
a filter attached to the nipple shield at a location permitting removal of leukocytes from breast milk.

16. The method according to claim 15, wherein said filter is attached inside of said protrusion.

17. The method according to claim 15, wherein said filter is a leukocyte reduction filter.

18. The method according to claim 15, wherein said filter is attached at a plurality of different locations along the protrusion to permit serial filtering of breast milk.

19. The method according to claim 15, wherein said nipple shield is made of a flexible material.

20. The method according to claim 19, wherein the flexible material is silicone or rubber.

21. The method according to claim 14, wherein said filter is part of a nipple device that is fitted onto a nursing bottle, said nipple device comprising:
a nipple having a base and a protrusion, wherein said protrusion has one or more holes permitting intake of breast milk by an infant, and
a filter attached to the nipple at a location permitting removal of leukocytes from breast milk.

22. The method according to claim 21, wherein said filter is attached inside of said protrusion.

23. The method according to claim 21, wherein said filter is a leukocyte reduction filter.

24. The method according to claim 21, wherein said filter is attached at a plurality of different locations along the protrusion to permit serial filtering of breast milk.

25. The method according to claim 21, wherein said nipple is made of a flexible material.

26. The method according to claim 25, wherein the flexible material is silicone or rubber.
